(19) United States
(12) Patent Application Publication
(10) Pub. No.: US 2005/0283752 A1
(43) Pub. Date: Dec. 22, 2005

(54) DiVAS-a cross-media system for ubiquitous gesture-discourse-sketch knowledge capture and reuse

(76) Inventors: Renate Fruchter, Los Altos, CA (US); Pratik Biswas, Stanford, CA (US); Zhen Yin, Los Altos, CA (US)

Correspondence Address: LUMEN INTELLECTUAL PROPERTY SERVICES, INC.;Second Floor, 2345 Yale Street, Palo Alto, CA, 94306, US

(21) Appl. No.: 11/132,171

(22) Filed: May 17, 2005

Related U.S. Application Data
(60) Provisional application No. 60/571,983, filed on May 17, 2004.
(60) Provisional application No. 60/572,178, filed on May 17, 2004.

(51) Int. Cl. G06F 17/24; G06F 9/44; G06F 9/45; G05B 19/42

(52) U.S. Cl. 717/100; 717/143; 717/116; 700/88

(57) ABSTRACT

The invention provides a cross-media software environment that enables seamless transformation of analog activities, such as gesture language, verbal discourse, and sketching, into integrated digital video-audio-sketching (DiVAS) for real-time knowledge capture, and that supports knowledge reuse through contextual content understanding.

### CROSS-REFERENCE TO RELATED APPLICATIONS

The present application claims priority from provisional patent application Nos. 60/571,983, filed May 17, 2004, and 60/572,178, filed May 17, 2004, both of which are incorporated herein by reference. The present application also relates to the U.S. patent application Ser. No. 10/824,063, filed Apr. 13, 2004, which is a continuation-in-part application of the U.S. patent application Ser. No. 09/568,090, filed May 12, 2000, U.S. Pat. No. 6,724,918, issued Apr. 20, 2004, which claims priority from a provisional patent application No. 60/133,782, filed on May 12, 1999, all of which are incorporated herein by reference.

### FIELD OF THE INVENTION

The invention generally relates to knowledge capture and reuse. More particularly, it relates to a Digital-Video-Audio-Sketch (DiVAS) system, method and apparatus integrating content of text, sketch, video, and audio, useful in retrieving and reusing rich content gesture-discourse-sketch knowledge.

### DESCRIPTION OF THE BACKGROUND ART

Knowledge generally refers to all the information, facts, ideas, truths, or principles learned throughout time. Proper reuse of knowledge can lead to competitive advantage, improved designs, and effective management. Unfortunately, reuse often fails because 1) knowledge is not captured; 2) knowledge is captured out of context, rendering it not reusable; or 3) there are no viable and reliable mechanisms for finding and retrieving reusable knowledge.

The digital age holds great promise to assist in knowledge capture and reuse. Nevertheless, most digital content management software today offers few solutions to capitalize on the core corporate competence, i.e., to capture, share, and reuse business critical knowledge. Indeed, existing content management technologies are limited to digital archives of formal documents (CAD, Word, Excel, etc.), and of disconnected digital images repositories and video footage. Of those that includes a search facility, it is done by keyword, date, or originator.

These conventional technologies ignore the highly contextual and interlinked modes of communication in which people generate and develop concepts, as well as reuse knowledge through gesture language, verbal discourse, and sketching. Such a void is understandable because contextual information in general is difficult to capture and re-use digitally due to the informal, dynamic, and spontaneous nature of gestures, hence the complexity of gesture recognition algorithms, and the video indexing methodology of conventional database systems.

In a generic video database, video shots are represented by key frames, each of which is extracted based on motion activity and/or color texture histograms that illustrate the most representative content of a video shot. However, matching between key frames is difficult and inaccurate where automatic machine search and retrieval are necessary or desired.

Clearly, there is a void in the art for a viable way of recognizing gestures to capture and re-use contextual information embedded therein. Moreover, there is a continuing need in the art for a cross-media knowledge capture and reuse system that would enable a user to see, find, and understand the context in which knowledge was originally created and to interact with this rich content, i.e., interlinked gestures, discourse, and sketches, through multimedia, multimodal interactive media. The present invention addresses these needs.

### SUMMARY OF THE INVENTION

It is an object of the present invention to assist any enterprise to capitalize on its core competence through a ubiquitous system that enables seamless transformation of the analog activities, such as gesture language, verbal discourse, and sketching, into integrated digital video-audio-sketching for real-time knowledge capture, and that supports knowledge reuse through contextual content understanding, i.e., an integrated analysis of indexed digital video-audio-sketch footage that captures the creative human activities of concept generation and development during informal, analog activities of gesture-discourse-sketch.

This object is achieved in DiVAS™, a cross-media software package that provides an integrated digital video-audio-sketch environment for efficient and effective ubiquitous knowledge capture and reuse. For the sake of clarity, the trademark symbol (™) for DiVAS and its subsystems will be omitted after their respective first appearance. DiVAS takes advantage of readily available multimedia devices, such as pocket PCs, Webpads, tablet PCs, and electronic whiteboards, and enables a cross-media, multimodal direct manipulation of captured content, created during analog activities expressed through gesture, verbal discourse, and sketching. The captured content is rich with contextual information. It is processed, indexed, and stored in an archive. At a later time, it is then retrieved from the archive and reused. As knowledge is reused, it is refined and becomes more valuable.

The DiVAS system includes the following subsystems:
(1) Information retrieval analysis (I-Dialogue™) for adding structure to and retrieving information from unstructured speech transcripts. This subsystem includes a vector analysis and a latent semantic analysis for adding clustering information to the unstructured speech transcripts. The unstructured speech archive becomes a clustered, semi-structured speech archive, which is then labeled using notion disambiguation. Both document labels and categorization information improve information retrieval.
(2) Video analysis (I-Gesture™) for gesture capture and reuse. This subsystem includes advanced functionalities, such as gesture recognition for object segmentation and automatic extraction of semantics from digital video. I-Gesture enables the creation and development of a well-defined, finite gesture vocabulary that describes a specific gesture language.
(3) Audio analysis (V2TS™) for voice capture and reuse. This subsystem includes advanced functionalities such as voice recognition, voice-to-text conversion, voice to text and sketch indexing and synchronization, and information retrieval techniques. Text is believed to be the most promising source for information retrieval. The information retrieval analysis applied to the audio/text portion of the indexed digital video-audio-sketch footage results in relevant discourse-text-samples linked to the corresponding video-gestures.
(4) Sketch analysis (RECALL™) for capturing, indexing, and replaying audio and sketch. This subsystem results in a sketch-thumbnail depicting the sketch up to the point, where the corresponding discourse starts, that is relevant to the knowledge reuse objective.

An important aspect of the invention is the gesture capture and reuse subsystem, referred to herein as I-Gesture. It is important because contextual information is often found embedded in gestures that augment other activities such as speech or sketching. Moreover, domain or profession specific gestures can cross cultural boundaries and are often universal.

I-Gesture provides a new way of processing video footage by capturing instances of communication or creative concept generation. It allows a user to define/customize a vocabulary of gestures through semantic video indexing, extracting, and classifying gestures via their corresponding time of occurrence from an entire stream of video recorded during a session. I-Gesture marks up the video footage with these gestures and displays recognized gestures when the session is replayed.

I-Gesture also provides the functionality to select or search for a particular gesture and to replay from the time when the selected gesture was performed. This functionality is enabled by gesture keywords. As an example, a user inputs a gesture keyword and the gesture-marked-up video archive are searched for all instances of that gesture and their corresponding timestamps, allowing the user to replay accordingly.

Still further objects and advantages of the present invention will become apparent to one of ordinary skill in the art upon reading and understanding the detailed description of the preferred embodiments and the drawings illustrating the preferred embodiments disclosed in herein.

### BRIEF DESCRIPTION OF THE DRAWINGS

FIG. 1 illustrates the system architecture and key activities implementing the present invention.

FIG. 2 illustrates a multimedia environment embodying the present invention.

FIG. 3 schematically shows an integrated analysis module according to an embodiment of the present invention.

FIG. 4 schematically shows a retrieval module according to an embodiment of the present invention.

FIG. 5A illustrates a cross-media search and retrieval model according to an embodiment of the present invention.

FIG. 5B illustrates a cross-media relevance model complementing the cross-media search and retrieval model according to an embodiment of the present invention.

FIG. 6 illustrates the cross-media relevance within a single session.

FIG. 7 illustrates the different media capturing devices, encoders, and services of a content capture and reuse subsystem.

FIG. 8 illustrates an audio analysis subsystem for processing audio data streams captured by the content capture and reuse subsystem.

FIG. 9 shows two exemplary graphical user interface of a video analysis subsystem: a gesture definition utility and a video processing utility.

FIG. 10 diagrammatically illustrates the extraction process in which a foreground object is extracted from a video frame.

FIG. 11 exemplifies various states or letters as video object segments.

FIG. 12 is a flow chart showing the extraction module process according to the invention.

FIG. 13 illustrates curvature smoothing according to the invention.

FIG. 14 is a Curvature Scale Space (CSS) graph representation.

FIG. 15 diagrammatically illustrates the CSS module control flow according to the invention.

FIG. 16 illustrates an input image and its corresponding CSS graph and contour.

FIG. 17 is a flow chart showing the CSS module process according to the invention.

FIG. 18 is an image of a skeleton extracted from a foreground object.

FIG. 19 is a flow chart showing the skeleton module process according to the invention.

FIG. 20 diagrammatically illustrates the dynamic programming approach of the invention.

FIG. 21 is a flow chart showing the dynamic programming module process according to the invention.

FIG. 22 is a snapshot of an exemplary GUI showing video encoding.

FIG. 23 is a snapshot of an exemplary GUI showing segmentation.

FIG. 24 shows an exemplary GUI enabling gesture letter addition, association, and definition.

FIG. 25 shows an exemplary GUI enabling gesture word definition based on gesture letters.

FIG. 26 shows an exemplary GUI enabling gesture sentence definition.

FIG. 27 shows an exemplary GUI enabling transition matrix definition.

FIG. 28 is a snapshot of an exemplary GUI showing an integrated cross-media content search and replay according to an embodiment of the invention.

FIG. 29 illustrates the replay module hierarchy according to the invention.

FIG. 30 illustrates the replay module control flow according to the invention.

FIG. 31 shows two examples of marked up video segments according to the invention: (a) a final state (letter) of a “diagonal” gesture and (b) a final state (letter) of a “length” gesture.

FIG. 32 illustrates an effective information retrieval module according to the invention.

FIG. 33 illustrates notion disambiguation of the information retrieval module according to the invention.

FIG. 34 exemplifies the input and output of the information retrieval module according to the invention.

FIG. 35 illustrates the functional modules of the information retrieval module according to the invention.

### DESCRIPTION OF THE INVENTION

We view knowledge reuse as a step in the knowledge life cycle. Knowledge is created, for instance, as designers collaborate on design projects through gestures, verbal discourse, and sketches with pencil and paper. As knowledge and ideas are explored and shared, there is a continuum between gestures, discourse, and sketching during communicative events. The link between gesture-discourse-sketch provides a rich context to express and exchange knowledge. This link becomes critical in the process of knowledge retrieval and reuse to support the user's assessment of the relevance of the retrieved content with respect to the task at hand. That is, for knowledge to be reusable, the user should be able to find and understand the context in which this knowledge was originally created and interact with this rich content, i.e., interlinked gestures, discourse, and sketches.

Efforts have been made to provide media-specific analysis solutions, e.g., VideoTraces by Reed Stevens of University of Washington for annotating a digital image or video, Meeting Chronicler by SRI International for recording the audio and video of meetings and automatically summarizing and indexing their contents for later search and retrieval, Fast-Talk Telephony by Nexidia (formerly Fast-Talk Communications, Inc.) for searching key words, phrases, and names within a recorded conversation or voice message, and so on.

The present invention, hereinafter referred to as DiVAS, is a cross-media software system or package that takes advantage of various commercially available computer/electronic devices, such as pocket PCs, Webpads, tablet PCs, and interactive electronic whiteboards, and that enables multimedia and multimodal direct manipulation of captured content, created during analog activities expressed through gesture, verbal discourse, and sketching. DiVAS provides an integrated digital video-audio-sketch environment for efficient and effective knowledge reuse. In other words, knowledge with contextual information is captured, indexed, and stored in an archive. At a later time, it is retrieved from the archive and reused. As knowledge is reused, it is refined and becomes more valuable.

There are two key activities in the process of reusing knowledge from a repository of unstructured informal data (gestures, verbal discourse, and sketching activities captured in digital video, audio, and sketches): 1) finding reusable items and 2) understanding these items in context. DiVAS supports the former activity through an integrated analysis that converts video images of people into gesture vocabulary, audio into text, and sketches into sketch objects, respectively, and that synchronizes them for future search, retrieval and replay. DiVAS also supports the latter activity with an indexing mechanism in real-time during knowledge capture, and contextual cross-media linking during information retrieval.

To perform an integrated analysis and extract relevant content (i.e., knowledge in context) from digital video, audio, sketch footage it is critical to convert the unstructured, informal content capturing gestures in digital video, discourse in audio, and sketches in digital sketches, into symbolic representations. Highly structured representations of knowledge are useful for reasoning. However, conventional approaches usually require manual pre or post processing, structuring and indexing of knowledge, which are time-consuming and ineffective processes.

The DiVAS system provides efficient and effective contextual knowledge capture and reuse with the following subsystems:
(1) Information retrieval and structuring (I-Dialogue™)—this subsystem enables effective information retrieval from speech transcripts using notion disambiguation and adds structure, i.e., clustering information, to unstructured speech transcripts via vector analysis and LSI (Latent Semantic Analysis). Consequently, an unstructured speech archive becomes a semi-structured speech archive. These clusters are labeled using notion disambiguation. Both document labels and categorization information improve information retrieval.
(2) Video analysis (I-Gesture™)—this subsystem captures and reuses gestures with advanced techniques such as gesture recognition for object segmentation and automatic extraction of semantics out of digital video. I-Gesture enables the creation, development, and customization of a well-defined, finite gesture vocabulary that describes a specific gesture language applicable to the video analysis. This video analysis results in a marked-up video footage using a customizable video-gesture vocabulary.
(3) Audio analysis: (V2TS™)—this subsystem captures and reuses speech sounds with advanced techniques such as voice recognition (e.g., Dragon, MS Speech Recognition) for voice-to-text conversion, voice-to-text-and-sketch (V2TS) indexing and synchronization, and information retrieval techniques. Text is by far the most promising source for information retrieval. The information retrieval analysis applied to the audio/text portion of the indexed digital video-audio-sketch footage results in relevant discourse-text-samples linked to the corresponding video-gestures.
(4) Sketch analysis (RECALL™)—this subsystem captures, indexes, and replays audio and sketches for knowledge reuse. It results in a sketch-thumbnail depicting the sketch up to a particular point, where the corresponding discourse starts, that is relevant to the knowledge reuse objective. As an example, it allows a user to “recall” from a point of conversation regarding a particular sketch or sketching activity.
   DiVAS System Architecture

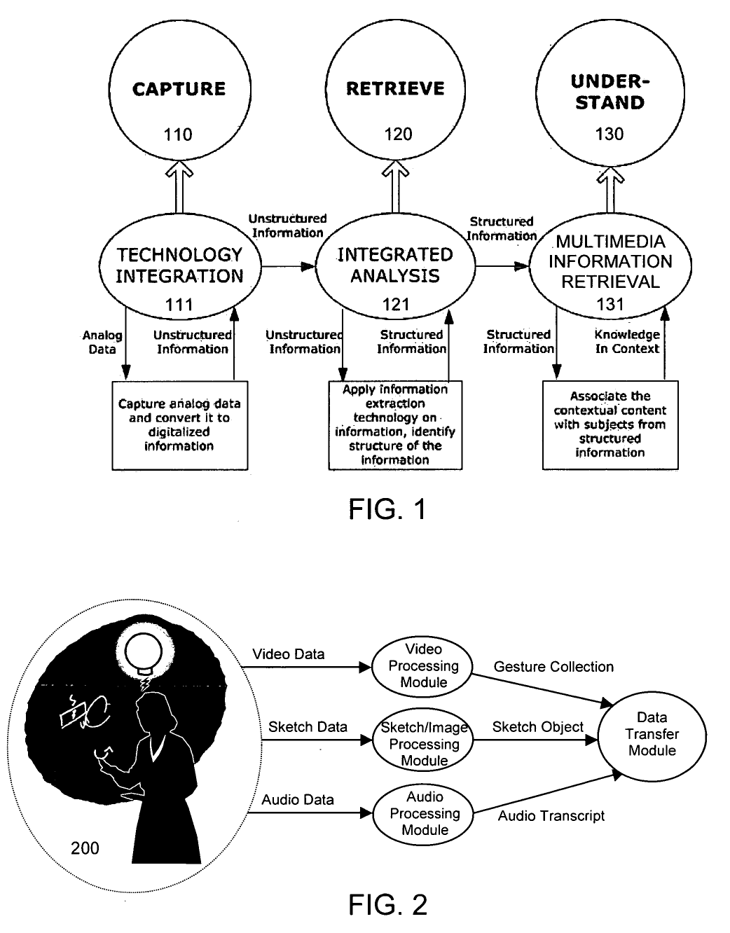

FIG. 1 illustrates the key activities and rich content processing steps that are essential to effective knowledge reuse—capture 110, retrieve 120, and understand 130. The DiVAS system architecture is constructed around these key activities. The capture activity 110 is supported by the integration 111 of several knowledge capture technologies, such as the aforementioned sketch analysis referred to as RECALL. This integration seamlessly converts the analog speech, gestures, and sketching activities on paper into digital format, bridging the analog world with digital world for architects, engineers, detailers, designers, etc. The retrieval activity 120 is supported through an integrated retrieval analysis 121 of captured content (gesture vocabulary, verbal discourse, and sketching activities captured in digital video, audio, and sketches). The understand activity 130 is supported by an interactive multimedia information retrieval process 131 that associates contextual content with subjects from structured information.

FIG. 2 illustrates a multimedia environment 200, where video, audio, and sketch data might be captured, and three processing modules—video processing module (I-Gesture), sketch/image processing module (RECALL), and audio processing module (V2TS and 1-Dialogue).

Except a few modules, such as the digital pen and paper modules for capturing sketching activities on paper, most modules disclosed herein are located in a computer server managed by a DiVAS user. Media capture devices, such as a video recorder, receive control requests from this DiVAS server. Both capture devices and servers are ubiquitous for designers so that the capture process is non-intrusive for them.

In an embodiment, the sketch data is in Scalable Vector Graphic (SVG) format, which describes 2D graphics according to the known XML standard. To take full advantage of the indexing mechanism of the sketch/image processing module, the sketch data is converted to proprietary sketch objects in the sketch/image processing module. During the capturing process, each sketch is assigned a timestamp. As the most important instance of a sketch object, this timestamp is used to link different media together.

The audio data is in Advanced Streaming Format (ASF). The audio processing module converts audio data into text through a commercially available voice recognition technology. Each phrase or sentence in the speech is labeled by a corresponding timeframe of the audio file.

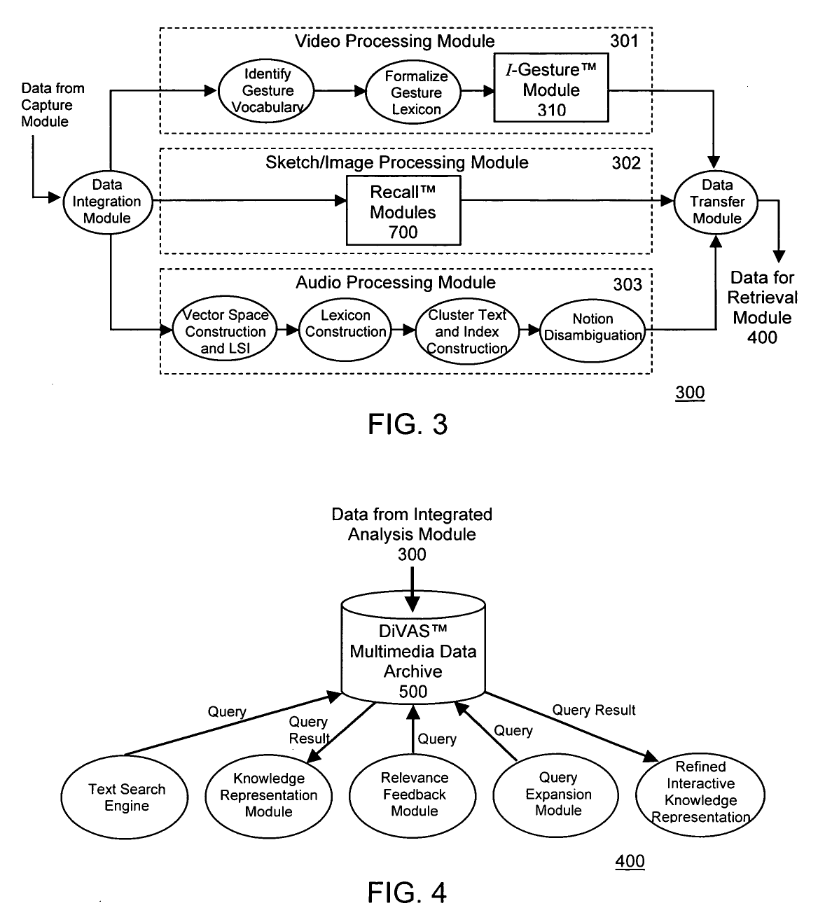

Similarly, the video data is also in ASF. The video processing module identifies gestures from video data. Those gestures compose the gesture collection for this session. Each gesture is labeled by a corresponding timeframe of the video file. At the end, a data transfer module sends all the processed information to an integrated analysis module 300, which is shown in detail in FIG. 3.

The objective of the integrated analysis of gesture language, verbal discourse, and sketch captured in digital video, audio, and digital sketch respectively is to build up the index, both locally for each media and globally across media. The local media index construction occurs first, along each processing path indicated by arrows. The cross-media index reflects whether content from gesture, sketch, and verbal discourse channels 301, 302, 303 are relevant to a specific subject.

FIG. 4 illustrates a retrieval module 400 of DiVAS. The gesture, verbal discourse, and sketch data from the integrated analysis module 300 is stored in a multimedia data archive 500. As an example, a user submits a query to the archive 500 starting with a traditional text search engine where keywords can be input with logical expression, e.g. “roof+steel frame”. The text search engine module processes the query by comparing the query with all the speech transcript documents. Matching documents are returned and ranked by similarity. The query results go through the knowledge representation module before being displayed to the user. In parallel, DiVAS performs a cross-media search of the contextual content from corresponding gesture and sketch channels.

Cross-Media Relevance and Ranking Model

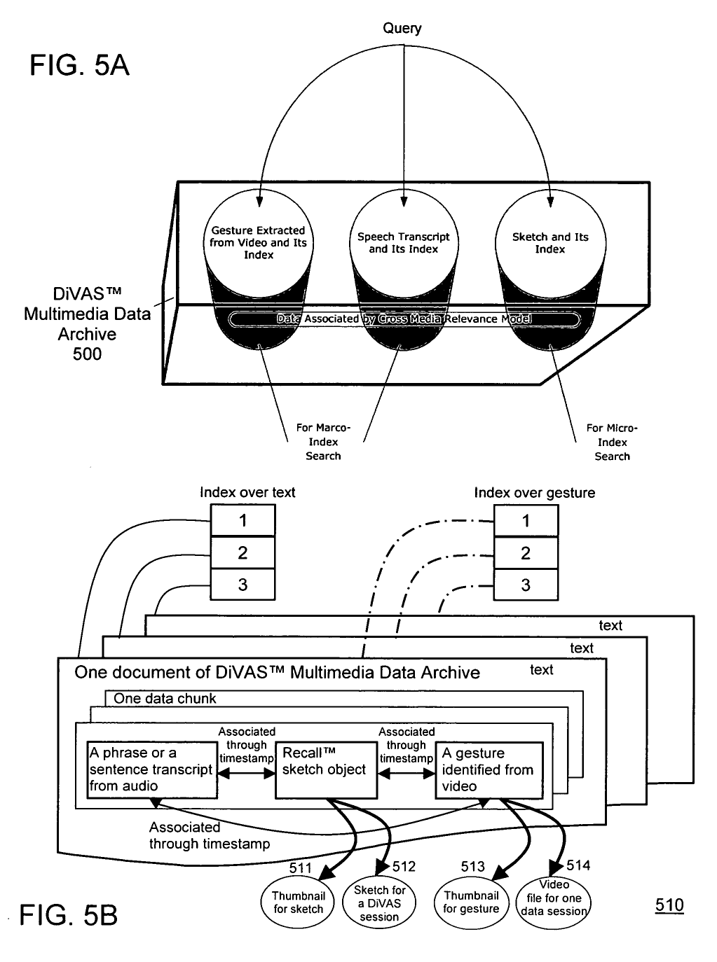

DiVAS provides a cross-media search, retrieval and replay facility to capitalize on multimedia content stored in large, multimedia, unstructured corporate repositories. Referring to FIG. 5A, a user submits a query to a multimedia data archive 500 that contains a keyword (a spoken phrase or gesture). DiVAS searches through the entire repository and displays all the relevant hits. Upon selecting a session, DiVAS replays the selected session from the point where the keyword was spoken or performed. The advantages of the DiVAS system are evident in the precise integrated and synchronized macro-micro indices offered by the video-gestures and discourse-text macro indices, and the sketch-thumbnail micro index.

The utility of DiVAS is most perceptible in cases where a user has a large library of very long sessions and wants to retrieve and reuse only the items that are of interest (most relevant) to him/her. Current solutions for this requirement tend to concentrate only on one stream of information. The advantage of DiVAS is literally three-fold because the system allows the user to measure the relevance of his query via three streams—sketch, gesture and verbal discourse. In that sense, it provides the user with a true ‘multisensory’ experience. This is possible because, as will be explained in later sections, in DiVAS, the background processing and synchronization is performed by an applet that uses multithreading to manage the different streams. A synchronization algorithm allows as many parallel streams as possible. It is thus possible to add even more streams or modes of input and output for a richer experience for the user.

During each multimedia session, data is captured from gesture, sketch, and discourse channels and stored in a repository. As FIG. 5B illustrates, the data from these three channels is dissociated within a document and across related documents. DiVAS includes a cross-media relevance and ranking model to address the need to associate the dissociated content such that a query expressed in one data channel would retrieve the relevant content from the other channels. Accordingly, users are able to search through gesture channel, speech channel, or both. When users are searching through both channels in parallel, the query results would be ranked based on the search results from both channels. Alternatively, query results could be ranked based on input from all three channels.

For example, if the user is interested in learning about the dimensions of the cantilever floor, his search query would be applied to both the processed gesture and audio indices for each of the sessions. Again, the processed gesture and audio indices would serve as a ‘macro index’ to the items in the archive. If there are a large number of hits for a particular session and the hits are from both audio and video, the possible relevance to the user is much higher. In this case, the corresponding gesture could be one corresponding to width or height and corresponding phrase could ‘cantilever floor’. So both streams combine to provide more information to the user and help him/her make a better choice. In addition, the control over the sketch on the whiteboard provides a micro index to the user to effortlessly jump between periods within a single session.

The integration module of DiVAS compares the timestamp of each gesture with the timestamp of each RECALL sketch object and links the gesture with the closest sketch object. For example, each sketch object is marked by a series timestamp. This timestamp is used when recalling a session. Assume that we have a RECALL session that stores 10 sketch objects, marked by timestamps 1, 2, 3 . . . 10. Relative timestamp is used in this example. The start of the session is timestamp 0. The gesture or sketch object created at time 1 second is marked by timestamp 1.

If a user selects objects 4, 5, and 6 for replay, the session is replayed starting from object 4, which is the earliest object among these three objects. If gesture 2 is closer in time to object 4 than any other objects, then object 4 is assigned or otherwise associated to gesture 2. Thus, when object 4 is replayed, gesture 2 will be replayed as well.

This relevance association is bidirectional, i.e., when the user selects to replay gesture 2, object 4 will be replayed accordingly. A similar procedure is applied to speech transcript. Each speech phrase and sentence is also linked to or associated with the closest sketch object. DiVAS further extends this timestamp association mechanism. Sketch line strokes, speech phrase or sentence, and gesture labels are all treated as objects, marked and associated by their timestamps.

Referring to FIG. 5B, an archive 510 stores sketch objects, gestures, and speech transcripts. Each media has its local index. In an embodiment, the index of sketch objects is integrated with JAVA 2D GUI and stored with RECALL objects. This local index is activated by a replay applet, which is a functionality provided by the RECALL subsystem.

A DiVAS data archive can store a collection of thousands of DiVAS sessions. Each session includes different data chunks. A data chunk includes a phrase or a sentence from a speech transcript. A sketch object would be one data and a gesture identified from a video stream would be another data chunk. Each data chunk is linked with its closest sketch object, associated through timestamp. As mentioned above, this link or association is bidirectional so that the system can retrieve any medium first, and then retrieve the other relevant media accordingly. Each gesture data chunk points to both the corresponding timeframe in the video file (via pointer 514) and a thumbnail captured from the video (via pointer 513), which represents this gesture. Similarly, each sketch object points to the corresponding timestamp in the sketch data file (via pointer 512) and a thumbnail overview of this sketch (via pointer 511).

Through these pointers, a knowledge representation module can show two thumbnail images to a user with each query result. Moreover, a relevance feedback module is able to link different media together, regardless of the query input format. Indexing across DiVAS sessions is necessary and is built into the integrated analysis module. This index can be simplified using only keywords of each speech transcript.

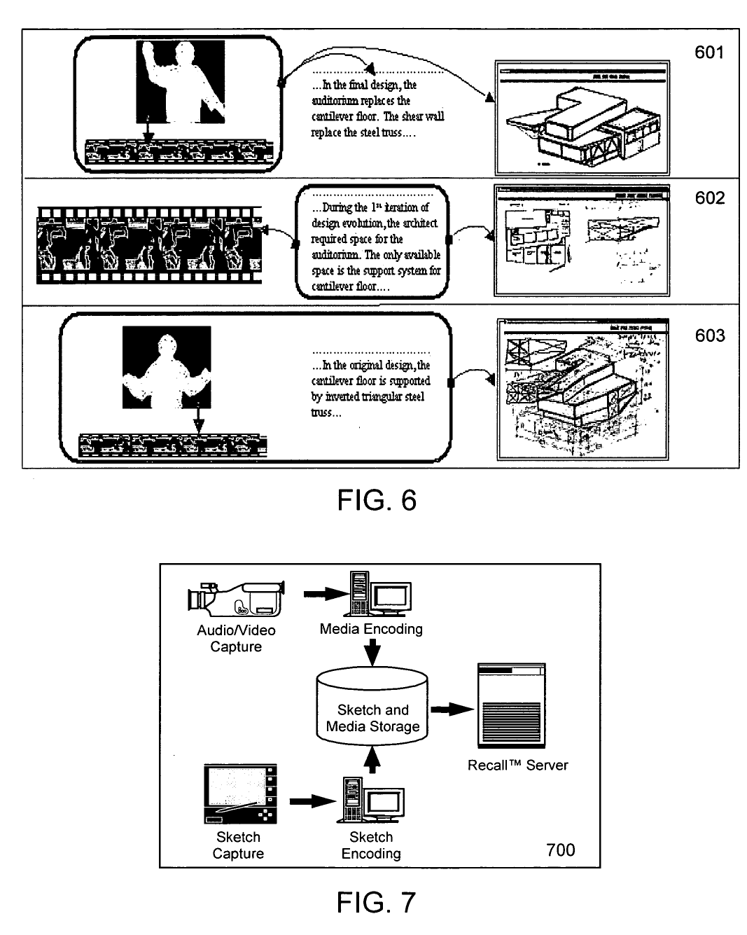

FIG. 6 illustrates different scenarios of returned hits in response to the same search query. In scenario 601, the first hit is found through I-Gesture video processing, which is synchronized with the corresponding text and sketch. In scenario 602, the second hit is found through text keyword/noun phrase search, which is synchronized with the video stream and sketch. In scenario 603, the third hit is found through both video and audio/text processing, which is synchronized with the sketch.

DiVAS Subsystems

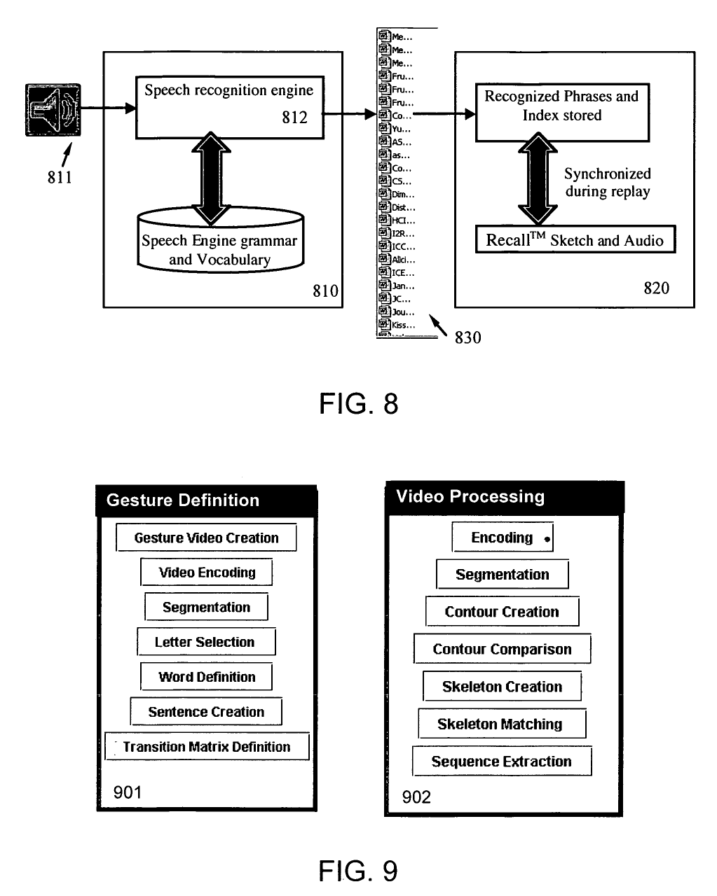

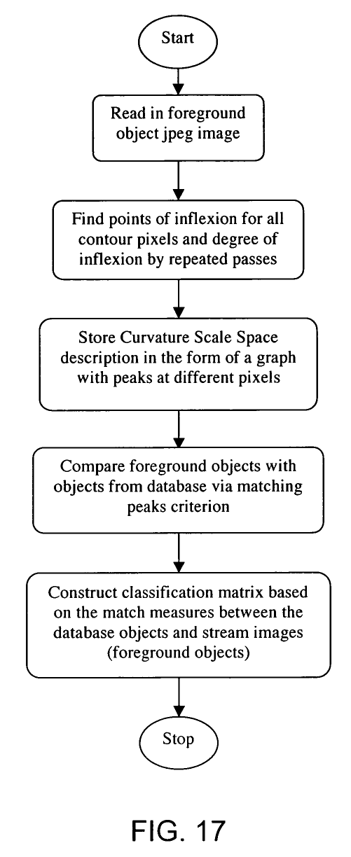

As discussed above, DiVAS integrates several important subsystems, such as RECALL, V2TS, I-Gesture, and I-Dialogue. RECALL will be described below with reference to FIG. 7. V2TS will be described below with reference to FIG. 8. I-Gesture will be described below with reference to FIGS. 9-31. I-Dialogue will be described below with reference to FIGS. 32-35.

The RECALL Subsystem

RECALL focuses on the informal, unstructured knowledge captured through multi-modal channels such as sketching activities, audio for the verbal discourse, and video for the gesture language that support the discourse. FIG. 7 illustrates the different devices, encoders, and services of a RECALL subsystem 700, including an audio/video capture device, a media encoding module, a sketch capture device, which, in this example, is a tablet PC, a sketch encoding module, a sketch and media storage, and a RECALL server serving web media applets.

RECALL comprises a drawing application written in Java that captures and indexes each individual action or activity on the drawing surface. The drawing application synchronizes with audio/video capture and encoding through client-server architecture. Once the session is complete, the drawing and video information is automatically indexed and published on the RECALL Web server for distributed and synchronized precise playback of the drawing session and corresponding audio/video, from anywhere, at anytime. In addition, the user is able to navigate through the session by selecting individual drawing elements as an index into the audio/video and jump to the part of interest. The RECALL subsystem can be a separate and independent system. Readers are directed to U.S. Pat. No. 6,724,918 for more information on the RECALL technology. The integration of the RECALL subsystem and other subsystems of DiVAS will be described in a later section.

The V2TS Subsystem

Verbal communication provides a very valuable indexing mechanism. Keywords used in a particular context provide an efficient and precise search criteria. The V2TS (Voice to Text and Sketch) subsystem processes the audio data stream captured by RECALL during the communicative event in the following way:
feed the audio file to a speech recognition engine that transforms voice-to-text
process text and synchronize it with the digital audio and sketch content
save and index recognized phrases
synchronize text, audio, sketch during replay of session
keyword text search and replay from selected keyword, phrase or noun phrase in the text of the session.

FIG. 8 illustrates two key modules of the V2TS subsystem. A recognition module 810 recognizes words or phrases from an audio file 811, which was created during a RECALL session, and stores the recognized occurrences and corresponding timestamps in text format 830. The recognition module 810 includes a V2T engine 812 that takes the voice/audio file 811 and runs it through a voice to text (V2T) transformation. The V2T engine 812 can be a standard speech recognition software package with grammar and vocabulary, e.g., Naturally Speaking, Via Voice, MS Speech recognition engine. A V2TS replay module 820 presents the recognized words and phrases and text in sync with the captured sketch and audio/video, thus enabling a real-time, streamed, and synchronized replay of the session, including the drawing movements and the audio stream/voice.

The V2TS subsystem can be a separate and independent system. Readers are directed to the above-referenced continuation-in-part application for more information on the V2TS technology. The integration of the V2TS subsystem and other subsystems of DiVAS will be described in a later section.

The I-Gesture Subsystem

The I-Gesture subsystem enables the semantic video processing of captured footage during communicative events. I-Gesture can be a separate and independent video processing system or integrated with other software systems. In the present invention, all subsystems form an integral part of DiVAS.

Gesture movements performed by users during communicative events encode a large amount of information. Identifying the gestures, the context, and the times when they were performed can provide a valuable index for searching for a particular issue or subject. It is not necessary to characterize or define every action that the user performs. In developing a gesture vocabulary, one can concentrate only on the ones that are relevant to a specific topic. Based on this principle, I-Gesture is built on a Letter-Word-Sentence (LWS) paradigm to gesture recognition in video streams.

A video stream comprises a series of frames, each of which basically corresponds to a letter representing a particular body state. A particular sequence of states or letters corresponds to a particular gesture or word. Sequences of gestures would correspond to sentences. For example, a man standing straight, stretching his hands, and then bringing his hands back to his body can be interpreted as a complete gesture. The individual frames could be looked at as letters and the entire gesture sequence as a word.

The objective here is not to precisely recognize each and every action performed in the video, but to find instances of gestures which have been defined by users themselves and which they find most relevant and specific depending on the scenario. As such, users are allowed to create an alphabet of letters/states and a vocabulary of words/gestures as well as a language of sentences/series of gestures.

As discussed before, I-Gesture can function independently and/or be integrated into or otherwise linked to other applications. In some embodiments, I-Gesture allows users to define and create a customized gesture vocabulary database that corresponds to gestures in a specific context and/or profession. Alternatively, I-Gesture enables comparisons between specific gestures stored in the gesture vocabulary database and the stream images captured in, for example, a RECALL session or a DiVAS session.

As an example, a user creates a video with gestures. I-Gesture extracts gestures from the video with an extraction module. The user selects certain frames that represent particular states or letters and specifies the particular sequences of these states to define gestures. The chosen states and sequences of states are stored in a gesture vocabulary database. Relying on this user-specified gesture information, a classification and sequence extraction module identifies the behavior of stream frames over the entire video sequence.

As one skilled in the art will appreciate, the modular nature of the system architecture disclosed herein advantageously minimizes the dependence between modules. That is, each module is defined with specific inputs and outputs and as long as the modules produce the same inputs and outputs irrespective of the processing methodology, the system so programmed will work as desired. Accordingly, one skilled in the art will recognize that the modules and/or components disclosed herein can be easily replaced by or otherwise implemented with more efficient video processing technologies as they become available. This is a critical advantage in terms of backward compatibility of more advanced versions with older ones.

FIG. 9 shows the two key modules of I-Gesture and their corresponding functionalities:
1. A gesture definition module 901 that enables a user to define a scenario-specific customized database of gestures.
2. A video processing module 902 for identifying the gestures performed and their corresponding time of occurrence from an entire stream of video.

Both the gesture definition and video processing modules utilize the following submodules:
a) An extraction module that extracts gestures by segmenting the object in the video that performs the gestures.
b) A classification module that processes the extracted object in each frame of the video and that classifies the state of the object in each frame.
c) A dynamic programming module that analyzes the sequences of states to identify actions (entire gestures or sequences of gestures) being performed by the object.

The extraction, classification and dynamic programming modules are the backbones of the gesture definition and video processing modules and thus will be described first, followed by the gesture definition module, the video processing module, and the integrated replay module.

The Extraction Module

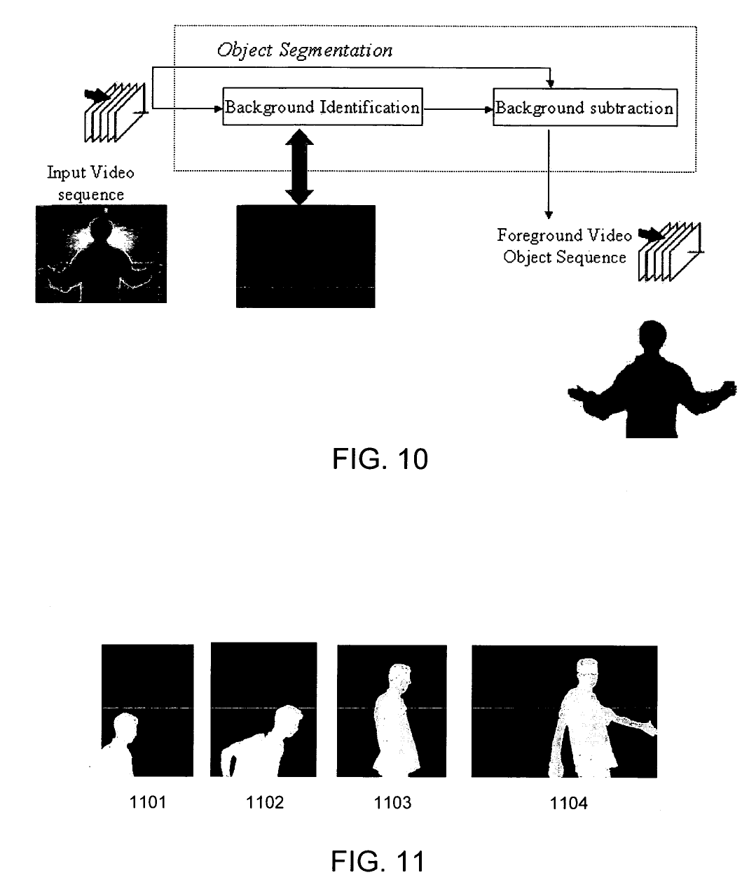

Referring to FIG. 10, an initial focus is on recognizing the letters, i.e., gathering information about individual frames. For each frame, a determination is made as to whether a main foreground object is present and is performing a gesture. If so, it is extracted from the frame. The process of extracting the video object from a frame is called ‘segmentation.’ Segmentation algorithms are used to estimate the background, e.g., by identifying the pixels of least activity over the frame sequence. The extraction module then subtracts the background from the original image to obtain the foreground object. This way, a user can select certain segmented frames that represent particular states or letters. FIG. 11 shows examples of video object segments 1101-1104 as states. In this example, the last frame 1104 represents a ‘walking’ state and the user can choose and add it to the gesture vocabulary database.

In a specific embodiment, the extraction algorithm was implemented on a Linux platform in C++. The Cygwin Linux Emulator platform with gcc compiler, jpeg and png libraries was used as well as a MPEG file decoder and a basic video processing library for operations like conversion between image data classes, file input/output (I/O), image manipulation, etc. As new utility programs and libraries become available, they can be readily integrated into I-Gesture. The programming techniques necessary to accomplish this are known in the art.

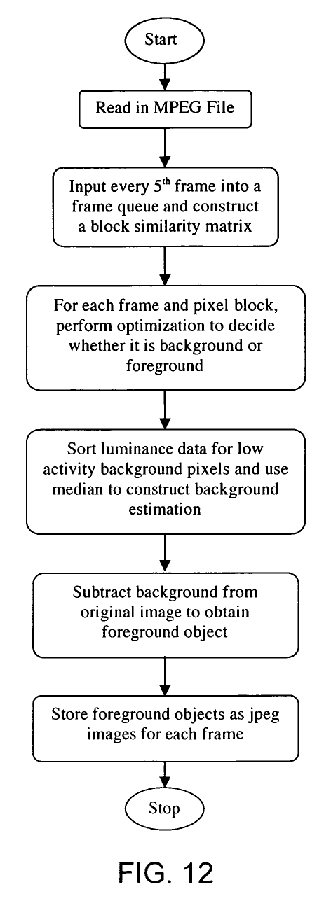

An example is presented below with reference to FIG. 12.
Working Directory C:/cygwin/home/user/gesture
Main program: gesture.cc
Input: Mpg file
1. Read in the video mpg file. Depending upon the resolution desired, every n^{th} frame is extracted and added to a frame queue. n by default is set to 5, in which case, every 5^{th} frame is extracted.
2. This queue of frames is used to create a block similarity matrix for each 8×8 block. The size of the matrix is LXL where L is the length of the sequence (in frames). Each matrix entry is the normalized difference between (i,j)^{th} frame for that block.
3. A linear optimization problem is solved to separate the frames that contain background from those that do not. As such, we have the foreground and background frames for each 8×8 block.
   The optimization problem for each block is
   Min Cost=sum(M(i,j))+sum(1-M(i,j)) sum over LXL matrix
      (background) (foreground)
4. For each of the background frames for a block, the luminance values are sorted and then median filtered to obtain a noise free estimate of the background luminance for that block. This gives an estimated background image.
5. Next, the background image is subtracted from each of the original video frames. The resulting image is the foreground image over all the frames. Each foreground object image is encoded and saved as a jpg image in the C:/cygwin/home/user/objdir directory with the name of the file indexed by the corresponding frame number.
6. The total number of frames in the video is also stored and could be used by a replay module during a subsequent replay.
   The Classification Module

Once the main object has been extracted, the behavior in each frame needs to be classified in a quantitative or graphical manner so that it can be then easily compared for similarity to other foreground objects.

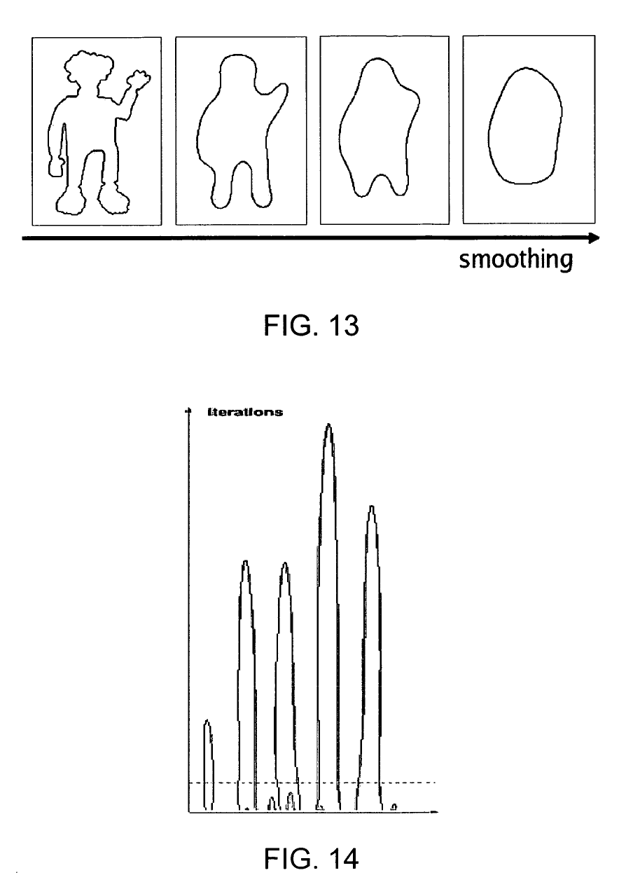

Two techniques are used for classification and comparison. The first one is the Curvature Scale Space (CSS) description based methodology. Accordingly to the CSS methodology, video objects can be accurately characterized by their external contour or shape. To obtain a quantitative description of the contour, the degree of curvature is calculated for the contour pixels of the object by repeatedly smoothing the contour and evaluating the change in curvature at each smoothing, see FIG. 13. The change in curvature corresponds to finding the points of inflexion on the contour, i.e., points at which the contour changes direction. This is mathematically encoded by counting for each point on the contour the number of iterations for which it was a point of inflexion. It can be graphically represented using a CSS graph, as shown in FIG. 14. The sharper points on the contour will stay more curved and will be the points of inflexion for more and more iterations of the smoothed contours and therefore will have high peaks and the smoother points will have lower peaks.

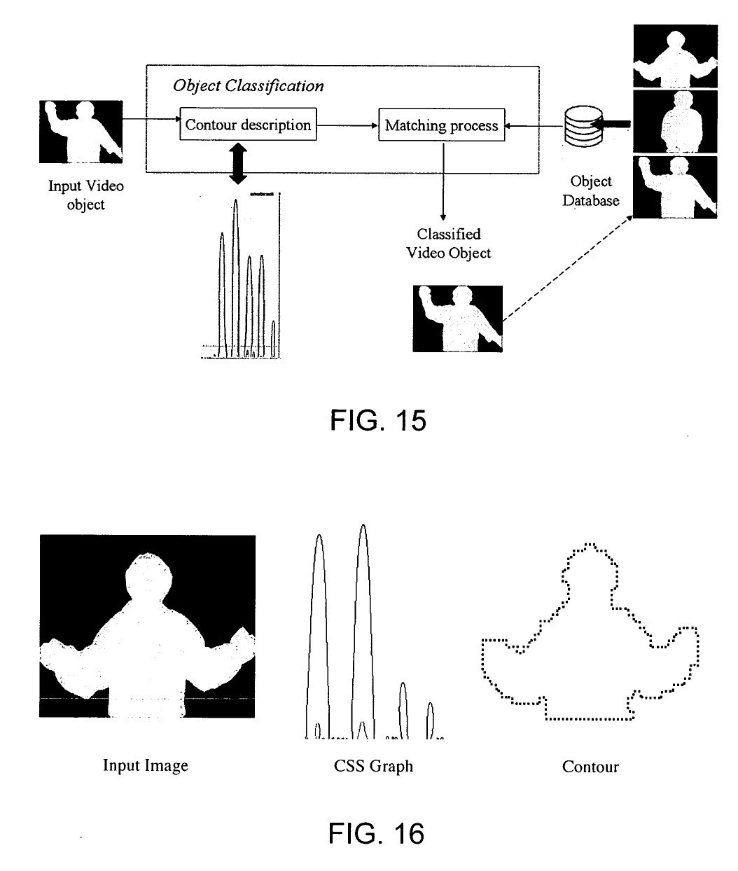

Referring to FIGS. 15-17, for comparison purposes, the matching peaks criterion is used for two different CSS descriptions corresponding to different contours. Contours are invariant to translations, so the same contour shifted in different frames will have a similar CSS description. Thus, we can compare the orientations of the peaks in each CSS graph to obtain a match measure between two contours.

Each peak in the CSS image is represented by three values: the position and height of the peak and the width at the bottom of the arc-shaped contour. First, both CSS representations have to be aligned. To align both representations, one of the CSS images is shifted so that the highest peak in both CSS images is at the same position.

A matching peak is determined for each peak in a given CSS representation. Two peaks match if their height, position and width are within a certain range. If a matching peak is found, the Euclidean distance of the peaks in the CSS image is calculated and added to a distance measure. If no matching peak can be determined, the height of the peak is multiplied by a penalty factor and added to the total difference.

This matching technique is used for obtaining match measures for each of the video stream frames with the database of states defined by the user. An entire classification matrix containing the match measures of each video stream image with each database image is constructed. For example, if there are m database images and n stream images, the matrix so constructed would be of size m×n. This classification matrix is used in the next step for analyzing behavior over a series of frames. A suitable programming platform for contour creation and contour based matching is Visual C++ with a Motion Object Content Analysis (MOCA) Library, which contains algorithms for CSS based database and matching.

An example of the Contour and CSS description based technique is described below:
Usage: CSSCreateData_dbg directory, FileExtension, Crop, Seq
Input: Directory of jpg images of Dilated Foreground Objects
Output: Database with Contour and CSS descriptions (.tag files with CSS info, jpeg files with CSS graphs and jpeg files with contour)

FileExtension helps identify what files to process. Crop specifies the cropping boundary for the image. Seq specifies whether it is a database or a stream of video to be recognized. In case it is a video stream, it also stores the last frame number in a file.

Contour Matching

Usage: ImgMatch_dbg, DatabaseDir, TestDir
Input: Two directories which need to be compared, database and the test directory
Output: File containing classification matrix based on match measures of database object for each test image. The sample output for an image is shown in FIG. 16.

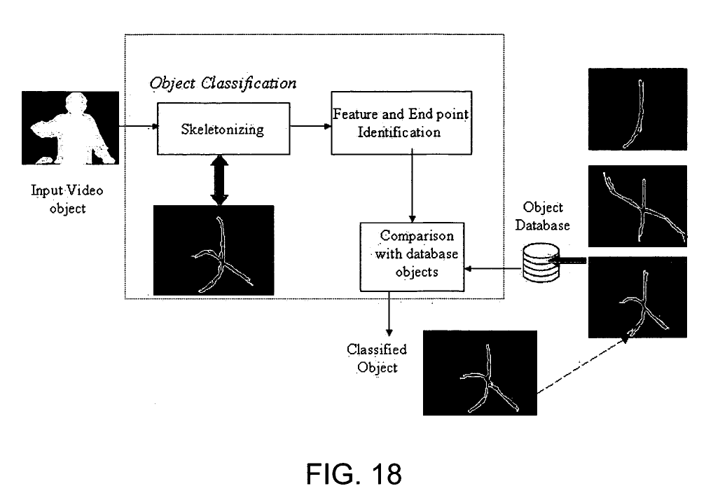

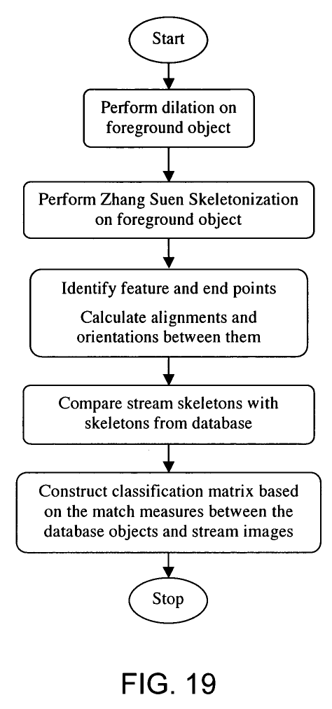

Referring to FIGS. 18-19, the second technique for classifying and comparing objects is to skeletonize the foreground object and compare the relative orientations and spacings of the feature and end points of the skeleton. Feature points are the pixel positions of the skeleton where it has three or more pixels in its eight neighborhoods that are also part of the skeleton. They are the points of a skeleton where it branches out in different directions like a junction. End points have only one point in the eight neighborhoods that is also part of the skeleton. As the name suggests, they are points where the skeleton ends.
1. The first step of skeletonization is to dilate the foreground image a little so that any gaps or holes in the middle of the segmented object get filled up. Otherwise, the skeletonizing step may yield erroneous results.
2. The skeletonizing step employs the known Zhang-Suen algorithm, a thinning filter that takes a grayscale image and returns its skeleton, see, T. Y. Zhang and C. Y. Suen, “A Fast Parallel Algorithm for Thinning Digital Patterns” Communications ACM, Vol. 27, No. 3, pp 236-239, 1984. The skeletonization retains at each step only pixels that are enclosed by foreground pixels on all sides.
3. The noisy parts of the image corresponding to the smaller disconnected pixels are removed using a region counting and labeling algorithm.
4. For description, the end and feature points for each skeleton are identified. Then the angles and the distances between each end point and its closest feature point are calculated. This serves as an efficient description of the entire skeleton.
5. To compare two different skeletons, a match measure based on the differences in the number of points and the calculated angles and distances between them is evaluated.
6. Construct a classification matrix in a manner similar to the construction in the CSS based comparison step. An entire classification matrix containing the match measures of each video stream image with each database image is constructed. For example, if there are m database images and n stream images, the matrix so constructed would be of size m×n. This classification matrix is used in the next step for analyzing behavior over a series of frames.

A suitable platform for developing skeleton based classification programs is the cygwin linux emulator platform, which uses the same libraries as the extraction module described above.

For example,
skelvid.cc
Usage: skelvid, mepgfilename
Input: Mpeg file
Output: Directory of Skeletonized objects in jpeg format
skelvidrec.cc
Usage: skelvidrec, databasedir, streamdir
Input: Two directories which need to be compared, database and stream directory
Output: File containing classification matrix showing match measures of each database object skeleton for each test skeleton
   The Dynamic Programming Module

Now that each and every frame of the video stream has been classified and a match measure obtained with every database state, the next task is to identify what the most probable sequence of states over the series of frames is and then identify which of the subsequences correspond to gestures. For example, in a video consisting of a person sitting, getting up, standing and walking, the dynamic programming algorithm decides what is the most probable sequence of states of sitting, getting up, standing and walking. It then identifies the sequences of states in the video stream that correspond to predefined gestures.

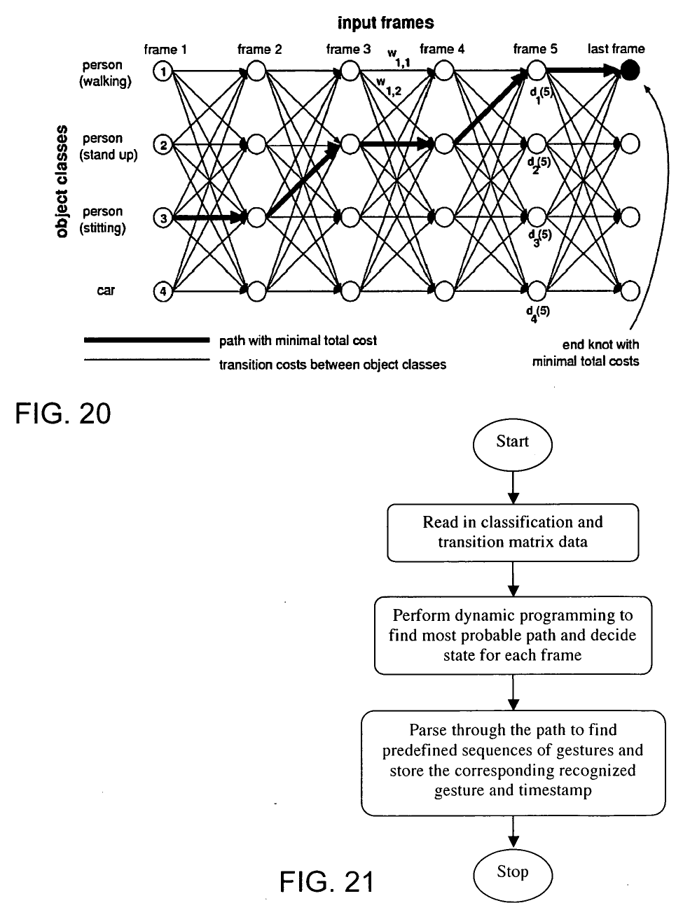

Referring to FIGS. 20-21, the dynamic programming approach identifies object behavior over the entire sequence. This approach relies on the principle that the total cost of being at a particular node at a particular point in time depends on the node cost of being at that node at that point of time, the total cost of being at another node in the next instant of time and also the cost of moving to that new node. The node cost of being at a particular node at a particular point in time is in the classification matrix. The costs of moving between nodes are in the transition matrix.

Thus, at any time at any node, to find the optimal policy, we need to know the optimal policy from the next time instant onwards and the transition costs between the nodes. In other words, the dynamic programming algorithm works in a backward manner by finding the optimal policy for the last time instant and using the information to find the optimal policy for the second last time instant. This is repeated till we have the optimal policy over all time instants.

As illustrated in FIG. 20, the dynamic programming approach comprises the following:
1. Read in edge costs, which are the transition costs between two sets of database states. For example, if the transition between two states is highly improbable, the edge cost is very high, and vice versa. A transition matrix stores the probability of one state changing to another. This information is read from a user specified transition matrix.
2. Read in node costs, which are matching peak differences between the object and database objects. This information is stored in the classification matrix and corresponds to the match measures obtained in the previous classification module, i.e., at this point the classification module already determined the node costs.
3. Find the minimum cost path over the whole decision matrix. Each of the frames is a stage at which an optimum decision has to be made, taking into consideration the transition costs and the node costs. The resulting solution or policy is the minimum cost path that characterizes the most probable object behavior for the video sequence.
4. After step 3, every frame is classified into a particular state, not only based on its match to a particular database state, but also using information from neighboring frames. If the minimum cost itself is beyond a threshold, it implies that the video stream under inspection does not contain any of the states or gestures defined in the database. In that case, the path is disregarded.
5. Once the behavior over the entire video is identified and extracted, the system parses through the path to identify the sequences in which the particular states occur. If a sequence of states defined by the user as a gesture is identified, the instance and its starting frame number are stored for subsequent replay.

The dynamic programming module is also written in the cygwin linux emulator in C++.
Usage: Dynprog, classification_file, transition_file, output_file
Classification_file: File containing classification matrix for a video stream
Transition_file: File containing transition matrix for collection of database states
Output_file: File to which recognized gestures and corresponding frame numbers are written.
   The Gesture Definition Module

Referring to FIGS. 9 and 22-27, the gesture definition module provides a plurality of functionalities to enable a user to create, define, and customize a gesture vocabulary database—a database of context and profession specific gestures against which the captured video stream images can be compared. The user creates a video with all the gestures and then runs the extraction algorithm to extract the foreground object from each frame. The user next selects frames that represent particular states or letters. The user can define gestures by specifying particular sequences of these states. The chosen states are processed by the classification algorithm and stored in a database. The stored states can be used in comparison with stream images. The dynamic programming module utilizes the gesture information and definition supplied by the user to identify behavior of stream frames over the entire video sequence.

The ability to define and adapt gestures, i.e., to customize gesture definition/vocabulary, is very useful because the user is no longer limited to the gestures defined by the system and can create new gestures or redefine or augment existing gestures according to his/her needs.

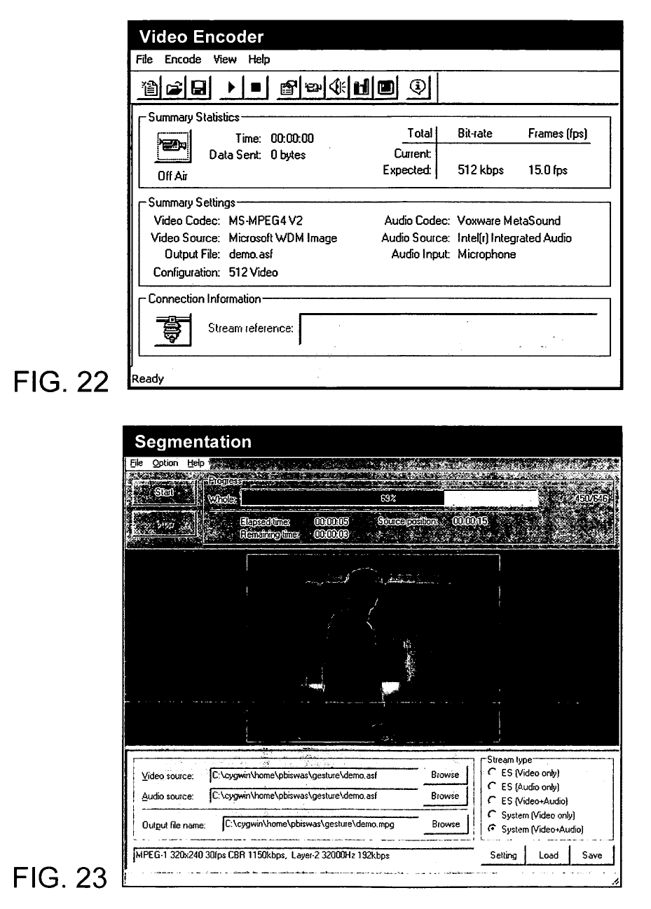

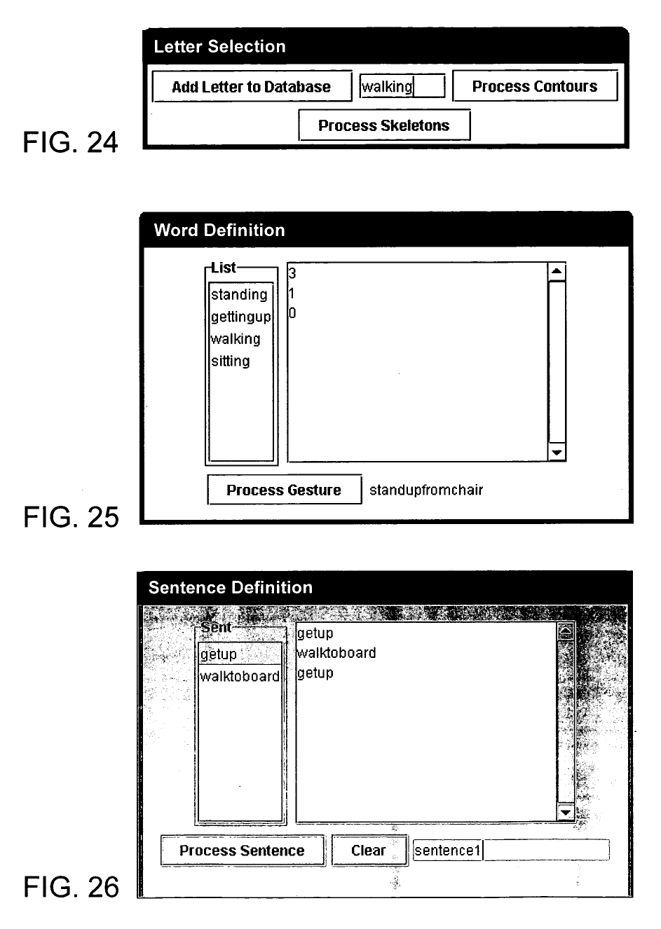

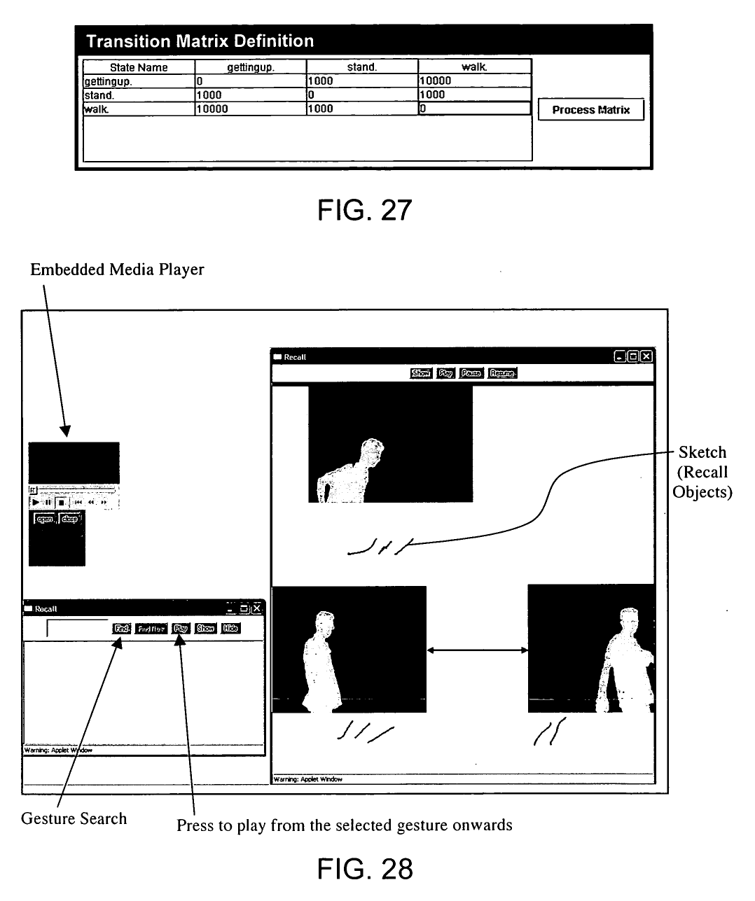

The GUI shown in FIGS. 22-27 is written in Java, with different backend processing and software.
1. The first step is to create a gesture video to define specific gestures. This is done by selecting or clicking the ‘Gesture Video Creation’ button upon which a video capture utility opens up. An off-the-shelf video encoder, such as the one shown in FIG. 22, may be employed. Upon selecting/clicking the play button, recording commences. The user can perform the required set of gestures in front of the camera and select/click on the stop button to stop recording.
   The encoder application is set up to save an .asf video file because this utility is to be integrated with RECALL, in which audio/video information is captured in .asf files. The integration is described in detail below. As one skilled in the art will appreciate, the present invention is not limited to any particular format, so long as it is compatible with the file format chosen for processing the video.
2. The .asf files need to be converted to mpg files, as shown in FIG. 23, because all video processing is done on mpg files in this embodiment. This step is skipped when the video capture utility captures video streams directly in the mpg format.
3. The user next selects/clicks on the ‘Segmentation’ button, upon which a file dialog opens up asking for the path to the mpg file, e.g., the output file shown in FIG. 23. The user selects the concerned mpg file. In response, the system executes the extraction module described above on the selected mpg file. The mpg file is examined frame by frame and the main object, i.e., the foreground object, performing the gestures in each frame is segmented out. A directory of jpeg images containing only the foreground object for each frame is saved.
4. Now that the user has a frame by frame foreground object set, he/she must choose the frames which define a critical state/letter in the gestures that he/she is interested in definmig. Upon choosing/clicking the ‘Letter Selection’ button, a file dialog opens up asking for the name of the target directory in which all the relevant frames should be stored. Once the name is given, a new window pops up, allowing the user to select a jpeg file of particular frame and define a letter representation thereof, as shown in FIG. 24.
   For example, a frame image with the hands stretched out horizontally could be a letter called ‘straight’. To add this letter to the database, the user enters the name of the letter/state to be added and selects/clicks on the ‘Add Letter to Database’ button. A file dialog opens up asking for the jpg file representing that particular letter. The user can select such a jpeg image from the directory of segmented images created via the segmentation module. After adding letters to the database, the user selects or clicks either the ‘Process Contours’ or the ‘Process Skeletons’ button. This initiates the classification module to process all of the images in the database directory and generate a corresponding contour or skeleton description thereof, as described above.
5. The user must define the relations between the letters, that is, in what sequence they occur for a particular gesture performed. A list of the letters defined in the target directory in step 4 is displayed, as shown in FIG. 25. When the user selects/clicks on a letter, its index is appended to a second list that stores sequences of letters. Once the user finishes defining a whole sequence, s/he can name and define a whole gesture by entering a gesture name, e.g., “standupfromchair”, and pressing the ‘Process Gesture’ button. The system accordingly stores the sequence of indices and the name of the gesture. This process can be repeated for as many sequences of letters/gestures as desired by the user. This step stores all the defined gestures onto a specified .txt file.
6. Similarly, sentences can be created out of the list of words by pressing the ‘Sentence Selection’ button. The user can then select from the list of words to make a sentence, as shown in FIG. 26. All the sentences are stored in a specified .txt file.
7. The final step in defining a complete gesture vocabulary is to create a transition matrix assigning appropriate costs for transitions between different states. Costs are high for improbable transitions, like a person sitting in a frame and standing in just the next frame. There must be an intermediate step where he/she is in almost standing or about to get up.
   With this in mind, the user enters/assigns appropriate costs to each of these transitions. For example, as shown in FIG. 27, the user may enter a cost of 10000 for a transition between ‘gettingup’ and ‘walk’ (highly improbable) and 1000 for a transition between ‘gettingup’ and ‘standing’ (more probable).
   The gesture data is normalized according to the costs in the classification matrix. Both matrices are used later for finding the most probable behavior path over the series of frames.
      The Video Processing Module

The video processing module processes the captured video, e.g., one that is created during a RECALL session, compare the video with a gesture database, identify gestures performed therein, and mark up the video, i.e., store the occurrences of identified gestures and their corresponding timestamps to be used in subsequent replay. Like the gesture definition module, the interface is programmed in Java with different software and coding platforms for actual backend operations.
1. Referring to FIG. 9, the first step is similar to the ‘Encoding’ step in the gesture definition module. That is, converting the .asf file into a format, e.g., mpg, recognizable by the extraction module.
2. Next, the mpg file is processed to obtain the foreground object in each frame, similar to the ‘Segmentation’ step described above in the gesture definition module section. This process is initiated upon the user selecting/clicking the ‘Segmentation’ functionality button and specifying the mpg file in the corresponding file dialog window.
3. Similar to the ‘Letter Selection’ step described above in the gesture definition module section, the ‘Contour Creation’ functionality opens a file dialog window asking for the directory of segmented images. In response to user input of the directory, the system invokes the contour classification module to process each segmented foreground jpg image in the directory to obtain a contour based description thereof, as described above in the classification module section.
4. Upon selecting/clicking the ‘Contour Comparison’ functionality button, the user is asked to specify a particular gesture letter database. That is, a directory of gesture letters and their classification descriptions which can be generated using the gesture definition module. The user is next asked for the directory containing the contour descriptions of the video stream of the session generated in the previous step. Finally, the user is asked for the name of the output file in which the comparisons between each of the letters in the database and the session video frames need to be stored. This set of comparisons is the same classification matrix used in the dynamic programming module described above.
5. Upon selecting/clicking the ‘Skeleton Creation’ functionality button, the user is asked for the directory of segmented images. In response to user input of the directory, the system invokes the skeleton creation module described above to process each segmented foreground jpg image in the directory to obtain a skeleton based description thereof, as described above in the classification module section.
6. Upon selecting/clicking the ‘Skeleton Matching’ functionality button, the user is asked to specify a particular gesture letter database, that is, a directory of gesture letters and their classification descriptions that can be generated using the gesture definition module. Next, the user is asked for the directory containing the skeleton descriptions of the video stream of the session generated in the previous step. Finally, the user is asked for the name of the output file in which the comparisons between each of the letters in the database and the session video frames need to be stored. Again, this set of comparisons is the same classification matrix used in the dynamic programming module described above.
7. Upon selecting/clicking the ‘Sequence Extraction’ functionality button, the user is asked for the classification matrix file, the name of the transition matrix file, the name of the gesture file, and the name of the project, e.g., a RECALL project. The details regarding the actual extraction of sequences are described above in the dynamic programming module section.
   It is important to note that each of these has been previously generated via either the gesture definition module or the same module. The system runs the dynamic programming module with these inputs and identifies the gestures performed within the video session. It then stores the gestures and the corresponding timestamps in a text (.txt) file under a predetermined directory. This file is subsequently used by the replay module described below.
      The Replay Module

All the effort to process the video streams and extract meaningful gestures is translated into relevant information for a user in the search and retrieval phase. I-Gesture includes a search mechanism that enables a user to pose a query based on keywords describing the gesture or a sequence of gestures (i.e., a sentence). As a result of this search I-Gesture returns all the sessions with the specific pointer where the specific gesture marker was found. The replay module uses the automatically marked up video footage to display recognized gestures when the session is replayed. Either I-Gesture or DiVAS will start to replay the video or the video-audio-sketch from the selected session displayed in the search window (see FIG. 28), depending upon whether the I-Gesture system is used independently or integrated with V2TS and RECALL.

The DiVAS system includes a graphical user interface (GUI) that displays the results of the integrated analysis of digital content in the form of relevant sets of indexed video-gesture, discourse-text-sample, and sketch-thumbnails. As illustrated in FIG. 28, a user can explore and interactively replay RECALL/DiVAS sessions to understand and assess reusable knowledge.

In embodiments where I-Gesture is integrated with other software systems, e.g., RECALL or V2TS (Voice to Text and Sketch), the state of the RECALL sketch canvas at the time the gesture was performed, or a part of the speech transcript of the V2TS session corresponding to the same time, can also be displayed, thereby giving the user more information about whether the identified gesture is relevant to his/her query. In this example, when the user selects/clicks on a particular project, the system writes the details of the selected occurrence onto a file and opens up a browser window with the concerned html file. In the mean time, the replay applet starts executing in the background. The replay applet also reads from the previously mentioned file the frame number corresponding to the gesture. It reinitializes all its data and child classes to start running from that gesture onwards. This process is explained in more details below.

An overall search functionality can be implemented in various ways to provide more context about the identified gesture. The overall search facility allows the user to search an entire directory of sessions based on gesture keywords and replay a particular session starting from the interested gesture. This functionality uses a search engine to look for a particular gesture that the user is interested in and displays on a list all the occurrences of that gesture in all of the sessions. Upon selecting/clicking on a particular choice, an instance of the media player is initiated and starts playing the video from the time that the gesture was performed. Visual information such as a video snapshot with the sequence of images corresponding to the gesture may be included.

To achieve synchronization during replay, all the different streams of data should be played in a manner so as to minimize the discrepancy between the times at which concurrent events in each of the streams occurred. For this purpose, we first need to translate the timestamp information for all the streams into a common time base. Here, the absolute system clock timestamp (with the time instant when the RECALL session starts set to zero) is used as the common time base. The sketch objects are encoded with the system clock timestamp during the RECALL session production phase.

The time of the entire session is known. The frame number when the gesture starts and the total number of frames in the session are known as well. Thus, the time corresponding to the gesture is
(Frame number of gesture/Total number of frames)*Total time for session.

To convert the timestamp into a common time base, we subtract the system clock timestamp for the instant the session starts, i.e.,
Sketch object timestamp=Raw Sketch object timestamp—Session start timestamp.

To convert the video system time coordinates, we multiply the timestamp obtained from an embedded media player and convert it into milliseconds. This gives us the common base timestamp for the video.

Since we already possess the RECALL session start and end times in system clock format (stored during the production session) and the start and end frame numbers tell us about the duration of the RECALL session in terms of number of frames (stored while processing by the gesture recognition engine), we can find the corresponding system clock time for a recognized gesture by scaling the raw frame data by a factor that is determined by the ratio of the time duration of the session in system clock and the time duration in frame. Thus,
Gesture timestamp=(Fg*Ds/FDr)+Tsst (System clock), where
   Fg=Frame number of gesture,
   Ds=(System clock session end time—System clock session start time),
   FDr=Frame Duration of the session, and
   Tsst=System clock applet start time.

The Tsst term is later subtracted from the calculated value in order to obtain the common base timestamp, i.e.,
Gesture timestamp=System clock keyword timestamp—Session start timestamp.

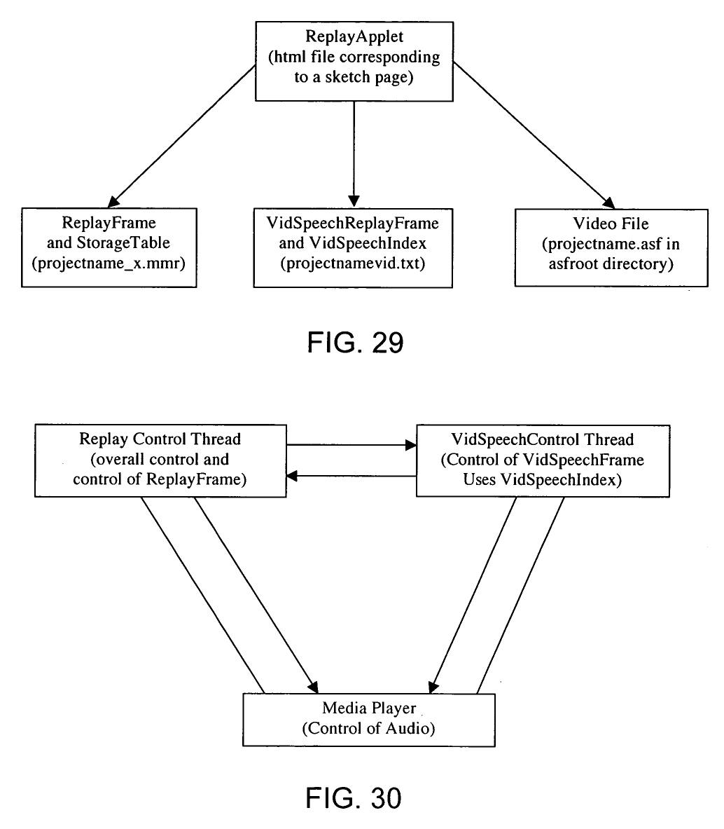

The replay module hierarchy is shown in FIG. 29. The programming for the synchronized replay of the RECALL session is written in Java 1.3. The important Classes and corresponding data structures employed are listed below:
1. Replay Applet: The main program controlling the replay session through an html file.
2. Storage Table: The table storing all the sketch objects for a single RECALL page.
3. VidSpeechindex: The array storing all the recognized gestures in the session.
4. ReplayFrame: The frame on which sketches are displayed.
5. VidSpeechReplayFrame: The frames on which recognized gestures are displayed.
6. ReplayControl: Thread coordinating audio/video and sketch.
7. VidSpeechReplayControl: Thread coordinating text display with audio/video and sketch.
8. RecallObject: Data structure incorporating information about single sketch object.
9. Phrase: Data structure incorporating information about single recognized gesture.

In the RECALL working directory
1. Projectname_x.html: Html file to display page x of RECALL session.
2. Projectname_x.mmr: Data File storing the Storage table for page x of the session, generated in the production phase of the RECALL session.
3. Projectnamevid.txt: Data File storing the recognized gestures for the entire session, generated from the recognition module.
3.2 Projectnamevidtemp.txt: Data File storing the queried gestures and its timestamp for the entire session.
3.4 Projectnamesp.txt: Data File storing the speech transcripts and corresponding timestamps, which are obtained from V2TS.

In asfroot directory
4. Projectname.asf: Audio File for entire session.

In an embodiment, the entire RECALL session is represented as a series of thumbnails for each new page in the session. A user can browse through the series of thumbnails and select a particular page.

Referring to FIG. 28, a particular RECALL session page is presented as a webpage with the Replay Applet running in the background. When the applet is started, it provides the media player with a link to the audio/video file to be loaded and starting time for that particular page. It also opens up a ReplayFrame which displays all of the sketches made during the session and a VidSpeechReplayFrame which displays all of the recognized gestures performed during the session.

The applet also reads in the RECALL data (projectname_x.mmr) file into a Storage Table and the recognized phrases file(projectnamesp.txt) into a VidSpeechIndex Object. VidSpeechIndex is basically a vector of Phrase objects with each phrase corresponding to a recognized gesture in the text file along with the start times and end times of the session in frame numbers as well as absolute time format to be used for time conversion. When reading in a Phrase, the initialization algorithm also finds the corresponding page, the number and time of the nearest sketch object that was sketched just before the phrase was spoken and stores it as a part of the information encoded in the Phrase data structure. For this purpose, it uses the time conversion algorithm as described above. This information is used by the keyword search facility.

At this point, we have an active audio/video file, a table with all the sketch objects and corresponding timestamps and page numbers and also a vector of recognized phrases (gestures) with corresponding timestamps, nearest object number and page number.

The replay module uses multiple threads to control the simultaneous synchronized replay of audio/video, sketch and gesture keywords. The ReplayControl thread controls the drawing of the sketch and the VidSpeechControl thread controls the display of the gesture keywords. The ReplayControl thread keeps polling the audio/video player for the audio/video timestamp at equal time intervals. This audio/video timestamp is converted to the common time base. Then the table of sketch objects is parsed, their system clock coordinates converted to the common base timestamp and compared with the audio/video common base timestamp. If the sketch object occurred before the current audio/video timestamp, it is drawn onto the ReplayFrame. The ReplayControl thread repeatedly polls the audio/video player for timestamps and updates the sketch objects on the ReplayFrame on the basis of the received timestamp.

The ReplayControl thread also calls the VidSpeechControl thread to perform this same comparison with the audio/video timestamp. The VidSpeechControl thread parses through the list of gestures in the VidSpeechindex and translates the raw timestamp (frame number) to common base timestamp and then compares it to the audio/video timestamp. If the gesture timestamp is lower, the gesture is displayed in the VidSpeechReplayFrame.

The latest keyword and latest sketch object drawn are stored so that parsing and redrawing all the previously occurring keywords is not required. Only new objects and keywords have to be dealt with. This process is repeated in a loop until all the sketch objects are drawn. The replay module control flow is shown in FIG. 30 in which the direction of arrows indicates direction of control flow.

The synchronization algorithm described above is an extremely simple, efficient and generic method for obtaining timestamps for any new stream that one may want to add to the DiVAS streams. Moreover, it does not depend on the units used for time measurement in a particular stream. As long as it has the entire duration of the session in those units, it can scale the relevant time units into the common time base.

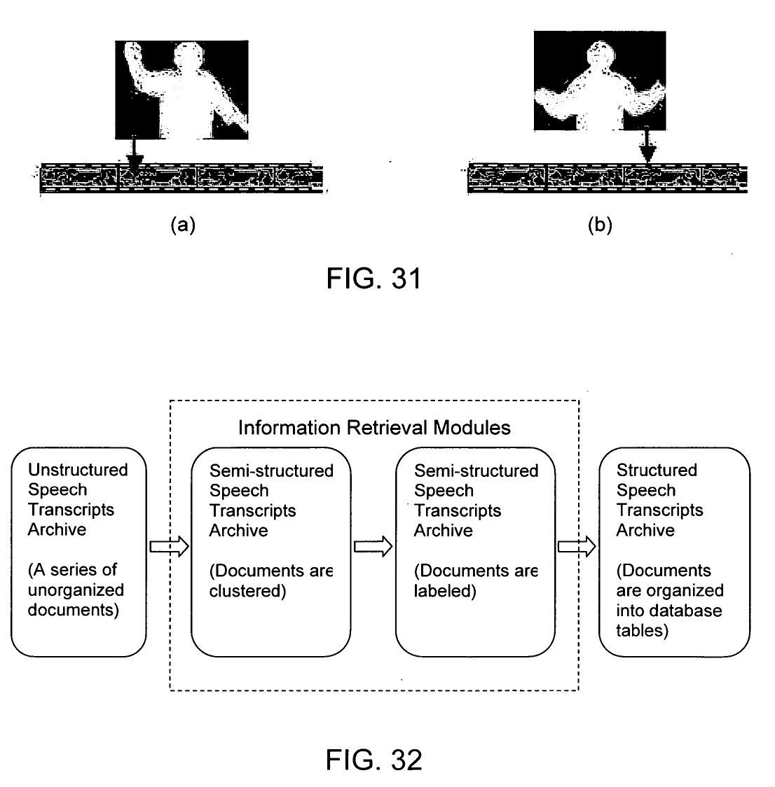

The synchronization algorithm is also completely independent of the techniques used for video image extraction and classification. FIG. 31 shows examples of I-Gesture marked up video segments: (a) final state (letter) of the “diagonal” gesture, (b) final state (letter) of the “length” gesture. So long as the system has the list of gestures with their corresponding frame numbers, it can determine the absolute timestamp in the RECALL session and synchronize the marked up video with the rest of the streams.

The I-Dialogue Subsystem

DiVAS is a ubiquitous knowledge capture environment that automatically converts analog activities into digital format for efficient and effective knowledge reuse. The output of the capture process is an informal multimodal knowledge corpus. The corpus data consists of “unstructured” and “dissociated” digital content. To implement the multimedia information retrieval mechanism with such a corpus, the following challenges need to be addressed:
How to add structure to unstructured content—Structured data tends to refer to information in “tables”. Unstructured data typically refers to free text. Semantic (meaning) and syntactic (grammar) information can be used to summarize the content from so-called unstructured data. In the context of this invention, unstructured data refers to the speech transcripts captured from the discourse channel, video, and sketches. Information retrieval requires an index construction over the data archive. The best medium to be indexed is text (speech transcripts). Both video data and sketch data are hard to index. Because of voice to text transcription errors (70-80% accurate), no accurate semantic and syntactic information is available for speech transcripts. Consequently, natural language processing models cannot be applied. The challenge is therefore how to add “structure” to the indexed speech transcripts to facilitate effective information retrieval.
How to process dissociated content—Each multimedia (DiVAS) session has data from gesture, sketch, and discourse channel. The data from these three channels is dissociated within a document and across related documents. A query expressed in one data channel should retrieve the relevant content from the other two channels. Query results should be ranked based on input from all relevant channels.

I-Dialogue addresses the need to add structure to the unstructured transcript content. The cross-media relevance and ranking model described above addresses the need to associate the dissociated content. As shown in FIG. 32, I-Dialogue adds clustering information to the unstructured speech transcript using vector analysis and LSI (Latent Semantic Analysis). Consequently, the unstructured speech archive becomes a semi-structured speech archive. Then, I-Dialogue uses notion disambiguation to label the clusters. Documents inside each cluster are assigned with the same labels. Both document labels and categorization information are used to improve information retrieval.

We define the automatically transcribed speech sessions as “dirty text”, which have transcription errors. The manually transcribed speech sessions are defined as “clean text”, which have no transcription errors. Each term or phrase, such as “the”, “and”, “speech archive”, “becomes”, are defined as “features”. The features that have clearly defined meaning in the domain of interest, such as “speech archive”, “vector analysis”, are defined as a “concept”. For clean text, there are many natural language processing theories to identify concepts from features. Generally, concepts can be used as labels for speech sessions, which summarize the content of sessions. However, those theories are not applicable to the dirty text processing due to the transcription errors. This issue is addressed by I-Dialogue with a notion (utterance) disambiguation algorithm, which is a key to the I-Dialogue subsystem.

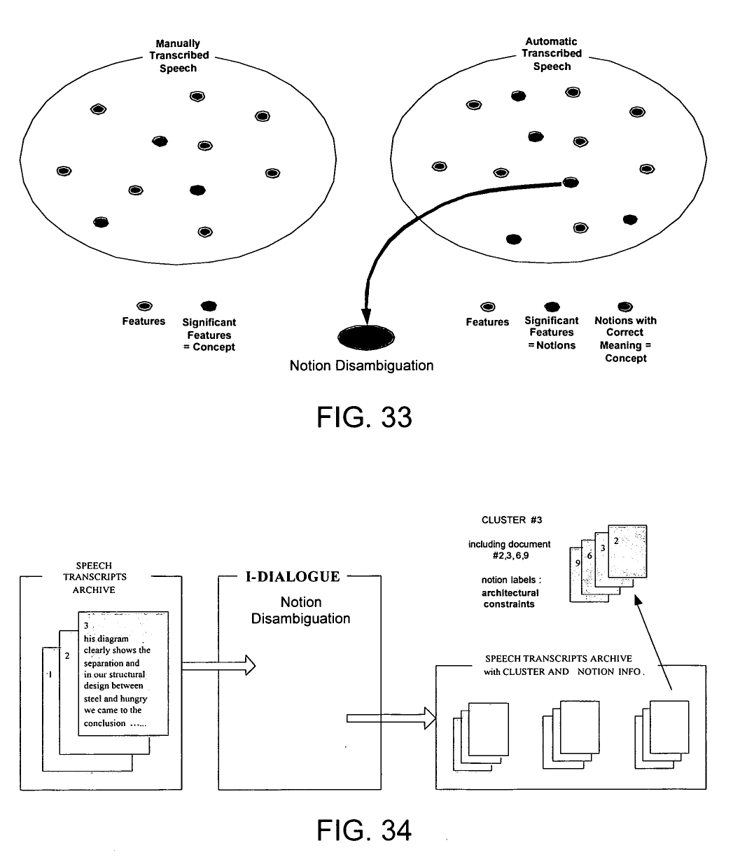

As shown in FIG. 33, documents are clustered based on their content. The present invention defines a “notion” as the significant features within document clusters. If clean text is being processed, the notion and the concept are equivalent. If the dirty text is being processed, a sample notion candidate set could be as follows: “attention rain”, “attention training”, and “tension ring”. The first two phrases actually represent the same meaning as the last phrase. Their presence is due to the transcription errors. We call the first two phrases the “noise form” of a notion and the last phrase as the “clean form” of a notion. The Notion Disambiguation algorithm is capable of filtering out the noise. In other words, the notion disambiguation algorithm can select “tension ring” from a notion candidate set and uses it as the correct speech session label.

The principle concepts for notion disambiguation are as follows:
Disambiguated notions can be used as informative speech session labels.
With the help of the reference corpus, the noise form of notions can be converted to the clean form.

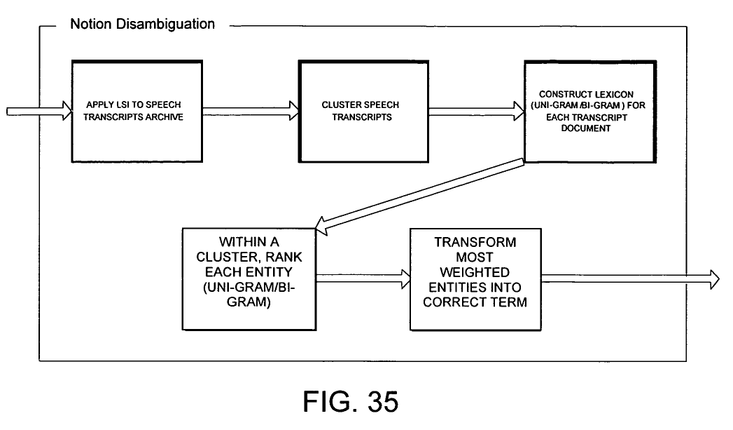

As shown in FIG. 34, the input for the I-Dialogue is an archive of speech transcripts. The output is the archive with added structure—the cluster information and notion label for each document. Term frequency based function is defined based on the document cluster, obtained via LSI. Original notion candidates are obtained from speech transcripts corpus. FIG. 35 shows the functional modules of I-Dialogue

DiVAS has a tremendous potential in adding new information streams. Moreover, as capture and recognition technologies improve, the corresponding modules and submodules can be replaced and/or modified without making any changes to the replay module. DiVAS not only provides seamless real-time capture and knowledge reuse, but also supports natural interactions such as gesture, verbal discourse, and sketching. Gesturing and speaking are the most natural modes for people to communicate in highly informal activities such as brainstorming sessions, project reviews, etc. Gesture based knowledge capture and retrieval, in particular, holds great promise, but at the same time, poses a serious challenge. I-Gesture offers new learning opportunities and knowledge exchange by providing a framework for processing captured video data to convert the tacit knowledge embedded in gestures into easily reusable semantic representations, potentially benefiting designers, learners, kids playing with video games, doctors, and other users from all walks of life.

As one skilled in the art will appreciate, most digital computer systems can be programmed to perform the invention disclosed herein. To the extent that a particular computer system configuration is programmed to implement the present invention, it becomes a digital computer system within the scope and spirit of the present invention. That is, once a digital computer system is programmed to perform particular functions pursuant to computer-executable instructions from program software that implements the present invention, it in effect becomes a special purpose computer particular to the present invention. The necessary programming-related techniques are well known to those skilled in the art and thus are not further described herein for the sake of brevity.

Computer programs implementing the present invention can be distributed to users on a computer-readable medium such as floppy disk, memory module, or CD-ROM and are often copied onto a hard disk or other storage medium. When such a program of instructions is to be executed, it is usually loaded either from the distribution medium, the hard disk, or other storage medium into the random access memory of the computer, thereby configuring the computer to act in accordance with the inventive method disclosed herein. All these operations are well known to those skilled in the art and thus are not further described herein. The term “computer-readable medium” encompasses distribution media, intermediate storage media, execution memory of a computer, and any other medium or device capable of storing for later reading by a computer a computer program implementing the invention disclosed herein.

Although the present invention and its advantages have been described in detail, it should be understood that the present invention is not limited to or defined by what is shown or described herein. As one of ordinary skill in the art will appreciate, various changes, substitutions, and alterations could be made or otherwise implemented without departing from the spirit and principles of the present invention. Accordingly, the scope of the present invention should be determined by the following claims and their legal equivalents.

1. A method of processing a video stream, comprising the step of:
enabling a user to define a scenario-specific gesture vocabulary database over selected segments of said video stream having an object performing gestures; and
according to said gesture vocabulary, automatically identifying gestures and their corresponding time of occurrence from said video stream.

2. The method according to claim 1, further comprising:
extracting said object from each frame of said video stream;
classifying state of said extracted object in each said frame; and
analyzing sequences of states to identify actions being performed by said object.

3. The method according to claim 2, further comprising:
determining a contour or shape of said object.

4. The method according to claim 2, further comprising:
determining a skeleton of said object.

5. The method according to claim 1, further comprising:
encoding said video stream into a predetermined format.

6. The method according to claim 1, further comprising:
enabling said user to specify a transition matrix that identifies transition costs between states.

7. The method according to claim 6, further comprising:
finding a minimum cost path over said transition matrix.

8. A computer system programmed to implement the method steps of claim 1.

9. A program storage device accessible by a computer, tangibly embodying a program of instructions executable by said computer to perform the method steps of claim 1.

10. A cross-media system, comprising:
an information retrieval analysis subsystem for adding structure to and retrieving information from unstructured speech transcripts;
a video analysis subsystem for enabling a user to define a scenario-specific gesture vocabulary database over selected segments of a video stream having an object performing gestures and for identifying gestures and their corresponding time of occurrence from said video stream.;
an audio analysis subsystem for capture and reusing verbal-discourse; and
a sketch analysis subsystem for capturing, indexing, and replaying audio and sketch.
